(19) United States
(12) Patent Application Publication
(10) Pub. No.: US 2014/0042099 A1
(43) Pub. Date: Feb. 13, 2014

(54) Oil Spill Treatment Compositions, Methods of Manufacture, and Methods of Use

(71) Applicant: EXXONMOBIL UPSTREAM RESEARCH COMPANY, HOUSTON, TX (US)

(72) Inventors: Timothy J. Nedwed, Houston, TX (US); Gerard P. Canevari, Cranford, NJ (US)

(21) Appl. No.: 14/052,446

(22) Filed: Oct. 11, 2013

Related U.S. Application Data
(63) Continuation of application No. PCT/US2012/033065, filed on Apr. 11, 2012.
(60) Provisional application No. 61/488,571, filed on May 20, 2011.

(51) Int. Cl. C02F 1/68

(52) U.S. Cl. CPC C02F 1/682
USPC 210/698; 210/696; 252/180; 556/465; 556/466

(57) ABSTRACT

An oil spill treatment composition including one or more surfactants formulated to reduce the thickness of oil floating the surface of a body of water, a method for use, and method of manufacturing thereof are disclosed herein. Also disclosed herein are oil spill treatment compositions comprising one or more chemical dispersants and one or more crude or refined oils having the same or similar composition as the oil spill to be treated. Methods for use thereof and methods of manufacture thereof are also disclosed.

### CROSS-REFERENCE TO RELATED APPLICATION

This application is a continuation of Intl Patent Application No. PCT/US2012/033065 that published as Intl. Patent App. Pub. No. 2012/161878 and was filed on 11 Apr. 2012, which claims the benefit of U.S. Patent Application No. 61/488,571 entitled OIL SPILL TREATMENT COMPOSITIONS, METHODS OF MANUFACTURE, AND METHODS OF USE, filed on May 20, 2011, the entirety of which is incorporated by reference herein.

### FIELD OF THE INVENTION

Embodiments of the present invention are directed toward oil spill treatments.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

The production of hydrocarbons, such as oil and gas, has been performed for numerous years. Occasionally, oil or fuel is accidentally released onto the surface of a body of water. This is generally referred to as an “oil spill.” When such an event occurs, the oil spill is evaluated and in many cases cleaned up. The accidental release of oil or other hydrocarbons in the marine environment often poses a significant threat to offshore, near-shore, and coastal areas. In many cases, immediate action may limit the extent of environmental impact.

One method of cleaning up the oil spill is by dispersing the oil into the water column below the surface to prevent surface oil from impacting sensitive areas. Liquid chemical treating agents (e.g., chemical dispersants) are generally used in such methods. Chemical dispersants are typically sprayed over the surface of an oil spill to reduce the interfacial tension between the oil and water and to allow wave action to break the oil spill into very small oil droplets. These small droplets disperse into the water column.

Conventional chemical dispersants have limitations that reduce their effectiveness for many real world situations. One limitation is that chemical dispersants require mixing energy in the form of waves to break surface oil slicks into small droplets that disperse into the water column. When wave energy is too low, dispersant-treated oil slicks will remain on the water surface until the wave energy increases.

Another limitation of chemical dispersants is the range of viscosity of oil that conventional dispersants can effectively treat. Conventional chemical dispersants tend to lose their effectiveness as the viscosity of the oil to be treated increases. Some oils naturally have higher viscosities than others (e.g., Bunker C). Even low viscosity crude oils weather over time into a more viscous liquid as their “light ends” dissipate. Other crude oils form emulsions with water that often have a higher viscosity than the crude oil by itself Further, oil tends to immediately increase in viscosity upon contact with cold water. The high viscosity of the oil may reduce the effectiveness of liquid dispersants by limiting the ability of the dispersant to interact with it. Many currently marketed liquid dispersants may tend to roll off or flow off the surface of the viscous oil and pass into the water column without dispersing the oil.

Some methods to improve the effectiveness of dispersants for viscous oils and emulsions involve formulating a more effective carrier solvent. Two such dispersants are COREXIT® 9500 and 9527 (manufactured by NALCO Chemical Co.). These dispersants are designed to be more effective because the carrier solvents remain in the oil film and resist extraction of the dispersant into the water column.

Another approach is disclosed in U.S. Pat. No. 4,560,482. This method utilizes a viscous, sticky, gel-like solvent that allows contact of the surfactants with the oil spill for a longer time interval to improve the likelihood that the oil will be dispersed into the water.

Further, another approach is disclosed in PCT Patent Publication No. WO2005/115603. This reference teaches the use of solid particles including a matrix component and an effective amount of a dispersant component. The solid particles are distributed over the surface of an oil spill and the solid matrix component dissolves to release the surfactant into the oil. The matrix component is oleophilic and does not tend to roll off of viscous oils.

The need still exists for new approaches to oil spill treatment and response. In particular, there is a need for new approaches to treat oil under low wave energy conditions, to treat viscous oils, and to break up oil-in-water emulsions.

### SUMMARY OF INVENTION

One or more embodiments of the present invention provide an oil spill treatment composition comprising one or more surfactants formulated to reduce the thickness of oil floating on the surface of a body of water.

One or more embodiments of the present invention further provide methods of treating spilled oil on a body of water comprising: providing an oil spill treatment composition, wherein the oil spill treatment composition comprises one or more surfactants formulated to reduce the thickness of a film of spilled oil floating on the surface of a body of water; and contacting the spilled oil with the oil spill treatment composition to spread at least a portion of the oil, thereby reducing the thickness of the film.

One or more embodiments of the present invention yet further provide methods of manufacturing an oil spill treatment composition comprising: admixing one or more selected surfactants to form an oil spill treatment composition formulated to reduce the thickness of a film of spilled oil, wherein the surfactant is one or more of: (a) a surfactant having a hydrophile-lipophile balance of less than about 10; and (b) a silicone having a low hydrophile-lipophile balance.

One or more embodiments of the present invention yet further still provide methods of manufacturing an oil spill treatment composition comprising: admixing one or more selected surfactants to form an oil spill treatment composition formulated to reduce the thickness of a film of spilled oil, and a crude or refined oil that has a composition the same as or similar to the spilled oil, wherein the crude or refined oil could be the spilled crude or refined oil that has been collected by skimmers during the spill event.

One or more embodiments of the present invention provide methods of manufacturing an oil spill treatment composition comprising: admixing a chemical dispersant, and a crude or refined oil that has a composition the same as or similar to the spilled oil, wherein the crude or refined oil could be the spilled crude or refined oil that has been collected by skimmers during the spill event.

### BRIEF DESCRIPTION OF THE DRAWINGS

The foregoing and other advantages of the present techniques may become apparent upon reviewing the following detailed description and drawings of non-limiting examples of embodiments in which:

FIGS. 1A to 1C are exemplary illustrations of the action of oil spill treatment composition comprising spreading agents.

FIGS. 2A to 2B are exemplary illustrations of the effect of thinning of the oil spill on entrained water droplets, such as those in an oil-in-water emulsion.

### DETAILED DESCRIPTION

In the following detailed description section, the specific embodiments of the present techniques are described in connection with preferred embodiments. However, to the extent that the following description is specific to a particular embodiment or a particular use of the present techniques, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

Embodiments herein relate to a new approach to oil spill response that utilizes an oil spill treatment composition comprising surfactants formulated to reduce the thickness of oil floating on the surface of a body of water. These compositions act as spreading agents, allowing thick oil slicks to spread to extremely thin sheens. Embodiments herein also relate to methods of reducing the impacts of offshore marine oil spills on marine, shoreline, and wetland habitats by promoting rapid spreading and thinning of any accidental oil spill releases, thereby enhancing the natural evaporation and dilution processes.

The increased surface area of the thin sheens most likely will enhance the evaporation of the more volatile components of the oil. These volatiles may be diluted by the process of evaporation, because the volatiles are liberated from entrainment in a spill of fixed dimensions into the uncontained open atmosphere. Accordingly, an entrained volatile present at a ppv (parts per volume) concentration in the oil spill that may be considered harmful may be diluted by evaporation to a ppv that is substantially less harmful. In a crude oil composition, the more volatile components typically comprise at least a component having an adverse impact on the environment. Furthermore, spreading the oil slick will increase the rate of evaporation of even larger, less volatile molecules, such as polycyclic aromatic hydrocarbons, however, because all compounds in oil exert a vapor pressure and evaporation rates are dependent on surface area. Accordingly, the inventors surmise that any residual oil that remains after spreading and subsequent evaporation of the volatile components will have less impact on the environment. In addition, spreading the oil may reduce areal loading of the oil and thereby result in very low concentrations of oil entering the water column if wave energy disperses the sheens.

Embodiments herein also relate to an approach to enhance the ability of chemical dispersants to disperse viscous oils, including emulsions. The inventors have surprisingly found that using a crude or refined oil that has a composition the same as or similar to the spilled oil as a solvent for the dispersant enhances the ability of these chemical dispersants to disperse viscous oils. The crude or refined oil may be the spilled crude or refined oil that has been collected by skimmers during the spill event. As used herein, “similar composition” means where oil has at least 10 to 99% of its components being the same as the oil to be treated and having a viscosity that is within an order of magnitude of the oil to be treated.

Such oil spill treatment compositions, methods of manufacturing these compositions, and methods of treating spilled oil are discussed, in turn, below.

### Oil Spill Treatment Compositions

One or more embodiments of the present invention provide an oil spill treatment composition comprising: one or more surfactants formulated to reduce the thickness of oil floating on the surface of a body of water.

The terms “oil spill,” “oil slick,” and “oil sheen” are used herein to refer to spilled oil on a body of water. “Oil spill” and “oil slick” are used interchangeably to refer to a film of oil covering part of the surface of a body of water. An oil spill may include water-in-oil emulsions such as “chocolate mousse” type emulsions. “Oil sheen” as used herein refers to oil slicks that have a film thickness of 0.08 microns or less.

The term “oil spill treatment composition” includes any surfactants disclosed herein to thin or spread oil. As used herein, “surfactant” refers to a soluble or partially soluble compound that reduces the surface tension of liquids, or reduces interfacial tension between two liquids, or a liquid and a solid by congregating and orienting itself at these interfaces.

Spreading factor/spreading pressures represent the balance between the interfacial tension at the air-water interface, oil-air interface, and oil-water interface. If cohesion within the oil slick (a function of the interfacial tension at the oil-air and oil-water interfaces) is greater than the surface tension at the water-air interface, then an oil slick is not expected to spread. The concept of the spreading agents is to modify interfacial tension such that the cohesive forces of the oil are reduced enough to allow spontaneous spreading on the water. Some embodiments herein comprise spreading agents, which are surfactants formulated to reduce the thickness of oil floating on the surface of a body of water.

In some embodiments, surfactants useful as spreading agents have a low hydrophile-lipophile balance (HLB). The HLB system is a classification system, typically for non-anionic surfactants, that represents the ratio of the water-soluble to the oil-soluble portions of a molecule. The HLB values are on a scale of 1 to 20, and are calculated by taking the percentage of the hydrophilic portion of the surfactant on a total molecular weight basis and dividing by 5. Accordingly, a higher HLB value means the surfactant has greater hydrophilic properties, while a higher HLB value means that the surfactant has greater lipophilic properties. In some embodiments, surfactants useful in compositions herein have a HLB of less than about 10, preferably about 5 or less. An example of a surfactant with low HLB that is useful herein is sorbitan monolaurate (Span® 20, available from Sigma Aldrich, St. Louis, Mo.).

In other embodiments, the surfactant is a silicone. As used herein, “silicone” means a polymer comprising atoms of silicon, carbon, hydrogen, and oxygen. Useful silicones have a high lipophilicity. The HLB system has been less than accurate for predicting the behavior of silicon-containing surfactants, especially those compositions that have silicone, hydrocarbon, and polyoxoalkylene portions present. Accordingly, manufacturers typically gauge the chemical behavior of these silicon-containing surfactants to be akin to that of “low” HLB surfactant, “medium” HLB surfactants, or “high” HLB surfactants. Silicones useful herein are low HLB surfactants. In some embodiments, the silicone is a crosslinked silicone, preferably a crosslinked alkylated silicone, for example, cetyl dimethicone, which is commercially available as Silwax® CR-5016 (Siltech LLC, Dacula, Ga.). In some embodiments, the silicone is a liquid at room temperature.

Surfactants useful herein as spreading agents, having a HLB of less than 10, are typically poor dispersants on their own. The term “dispersant” means any material regarded as a dispersant by persons skilled in the art of oil spill dispersion, and includes any material (solid, liquid, or mixture) that is capable of causing oil, including particularly a crude oil or a refined oil, to begin dispersing into the water column upon making contact with that oil, or shortly after making such contact. When oil is located at or near the surface of a body of water, e.g., as part of an oil spill or slick, a preferred dispersant is one that is capable of breaking up the oil on or near the surface of the body of water, causing the oil to form droplets and to disperse down into the water column where natural forces can degrade the oil droplets. Unless stated otherwise, any material that is a herding agent when applied to oil on a body of water is not a “dispersant.”

In some embodiments herein, the surfactant useful as a spreading agent is present in the composition in an amount sufficient to spread or thin the spilled oil. In some embodiments, the surfactant is present in the composition in an amount ranging from about 0.5 to 100 vol. %, preferably from about 40 to 60 vol. %. As used herein, “vol. %” means volume percent.

In other embodiments, the oil spill treatment composition further comprises a solvent. The solvents often provide at least two functions. First, they reduce the viscosity of surfactant and allow efficient application, such as via spraying. Second, solvents promote penetration and mixing of the composition into the oil spill or slick. In some embodiments, the solvent is one or more of an organic solvent, a silicon-containing compound, and a crude or refined oil having the same or similar composition as the oil to be treated. Preferred solvents include dearomatized kerosene, isoparafins, crude oil, refined oil, and ethylene glycols. In some embodiments, the solvent is present at 10 to 90 vol. %, preferably about 50 vol. %.

In preferred embodiments, the solvent comprises a crude or refined oil having the same or similar composition as the oil to be treated. Without wishing to be bound by theory, the inventors surmise that premixing the surfactant with the crude or refined oil facilitates effective penetration of the oil to be treated. In some embodiments, the volume ratio of the crude or refined oil to the surfactant is in the range of from about 10:90 to about 90:10, preferably from about 20:80 to about 80:20, more preferably from about 30:70 to 70:30, still more preferably about 50:50.

In yet other embodiments, the oil spill treatment composition further comprises at least one additive. As used herein, “additives” may include, but are not limited to, salts, surfactants, additional fluid-loss-control additives, gas, nitrogen, carbon dioxide, surface-modifying agents, tackifying agents, foamers, additional corrosion inhibitors, scale inhibitors, catalysts, clay-control agents, biocides, friction reducers, antifoam agents, bridging agents, dispersants, flocculants, H₂S scavengers, CO₂ scavengers, oxygen scavengers, lubricants, viscosifiers, breakers, weighting agents (e.g., barite), relative-permeability modifiers, resins, particulate materials (e.g., proppant particulates), wetting agents, coating-enhancement agents, and the like. In particular embodiments, the additive is a tackifying agent, for example, polyisobutylene.

In particular embodiments, the oil spill treatment composition comprises about 25 to 75 vol. % of cetyl dimethicone and about 25 to 75 vol. % crude or refined oil. In a preferred embodiment, the oil spill treatment composition comprises about 50 vol. % cetyl dimethicone and about 50 vol. % crude or refined oil.

Another embodiment of the present invention provides an oil spill treatment composition comprising: one or more chemical dispersant and one or more crude or refined oils having the same or similar composition as the oil to be to be treated. The inventors surmise that premixing the surfactant with the crude or refined oil facilitates effective penetration of the dispersant into the oil to be treated. In some embodiments, the volume ratio of the crude or refined oil to the dispersant is in the range of from about 10:90 to about 90:10, preferably from about 20:80 to about 80:20, more preferably from about 30:70 to 70:30, still more preferably about 50:50.

It is contemplated that any chemical dispersant known to those of skill in the art can be used for the oil spill treatment composition. Examples of chemical dispersants useful as a dispersant component are any of the components identified in U.S. Pat. No. 3,793,218, or U.S. Pat. No. 5,618,468, alone or in combination. The portions of those patents referring to the dispersants, including particularly the chemical formulas of the dispersants, are hereby incorporated by reference, as examples of the “chemical dispersant” discussed herein.

In certain embodiments, the oil spill composition may also comprise a combination, e.g., a blend or mixture, of different chemical dispersants. Some of these chemical dispersants are sold under known trademarks, have established proportions, and may be formulated in a carrier solvent. At least one example of a dispersant component is any of the dispersant chemicals in COREXIT® 9500 or COREXIT® 9527 sold by NALCO Chemical Company. At least one formulation of those products is composed of about 9.7 weight percent (wt %) SPAN® 80 (sorbitan monooleate); about 19.4 wt % TWEEN 80 (polyoxyethylene sorbitan monooleate); about 28.6 wt % TWEEN 85 (polyoxyethylene sorbitan trioleate), and about 42.3 wt % Aerosol OT (aqueous sodium dioctyl sulfosuccinate). An exemplary useful chemical dispersant mixture may include: (a) sorbitan monooleate (from about 5 to 15 wt %), (b) polyoxyethylene sorbitan monooleate (from about 15 to 25 wt %), (c) polyoxyethylene sorbitan trioleate (from about 20 to 40 wt %) and (d) sodium dioctyl sulfosuccinate (from about 25 to 50 wt %). More particularly, a dispersant mixture may include: (a) sorbitan monooleate (about 10 wt %), (b) polyoxyethylene sorbitan monooleate (about 20 wt %), (c) polyoxyethylene sorbitan trioleate (about 30 wt %) and (d) sodium dioctyl sulfosuccinate (40 wt %). In all cases, the total weight percent will not exceed 100%. As used herein, wt % means “weight percent.”

### Methods of Manufacture of Oil Spill Treatment Compositions

One or more embodiments of the present invention provide methods of manufacturing an oil spill treatment composition comprising: admixing one or more selected surfactants to form an oil spill treatment composition formulated to reduce the thickness of a film of spilled oil, wherein the surfactant is one or more of: (a) a surfactant having a hydrophile-lipophile balance of less than about 10; and (b) a silicone having a low hydrophile-lipophile balance.

In some embodiments, the method further comprises admixing a solvent. In particular embodiments, the solvent is a crude or refined oil, wherein the crude or refined oil has the same or similar composition as the spilled oil to be treated.

In yet other embodiments, the method further comprises admixing one or more additives. The addition of the additives may improve the viscosity, shelf life, appearance, or the like of the oil spill treatment composition.

One or more embodiments of the present invention provide methods of manufacturing an oil spill treatment composition comprising: admixing one or more chemical dispersant with one or more crude or refined oil, wherein the one or more crude or refined oil has the same or similar composition as the spill oil to be treated.

In yet other embodiments, the method further comprises admixing one or more additives. The addition of the additives may improve the viscosity, shelf life, appearance, or the like of the oil spill treatment composition.

The components of any of the compositions disclosed herein may be added sequentially, in combination, or in part. Some embodiments of the oil spill treatment composition may be mixed using standard mixing equipment and techniques known to those of skill in the art. Any suitable methods and apparatuses for storing, pumping, mixing and re-mixing the composition of the various embodiments known to those of skill in the art may be used. Some embodiments herein may include a step of re-mixing the composition should there be any separation of the surfactant and any other components during storage. Advantageously, the oil spill treatment composition may also be transported, applied and stored using standard equipment known to those of skill in the art.

### Methods of Treating Spilled Oil

One or more embodiments of the present invention further provide methods of treating spilled oil on a body of water comprising: providing an oil spill treatment composition, wherein the oil spill treatment composition comprises one or more surfactants formulated to reduce the thickness of a film of spilled oil floating on the surface of a body of water; and contacting the spilled oil with the oil spill treatment composition to spread at least a portion of the oil, thereby reducing the thickness of the film.

In some embodiments, the thickness of the film is reduced by at least 90%, preferably, at least 99%, preferably at least 99.9%, or preferably at least 99.99%. The relationship between oil film thickness and appearance was documented by Hoult (Oil on Sea, Plenum Press, 1969). The information in Table 1 allows estimation of oil film thickness from observations of the surface appearance.

TABLE 1
Oil Spill Appearance

| Film Thickness, | | Approximate |
|---|---|---|
| microns | Appearance of Oil Film | Gallons/Sq. Mile |
| 0.04 | Barely Visible | 25 |
| 0.08 | Silver Sheen | 50 |
| 0.16 | First Trace of Color | 100 |
| 0.32 | Bright Bands of Color | 200 |
| 2.0+ | Much Darker Colors | 1330+ |

Embodiments of the present invention may thin or spread viscous oil to a thickness that is visually not detectable.

The thinning of the oil spill after the contacting step may be visually observed using the oil spill appearance parameters in Table 1. If there is insufficient treatment, the oil spill treatment composition can be reapplied until the treatment is sufficient.

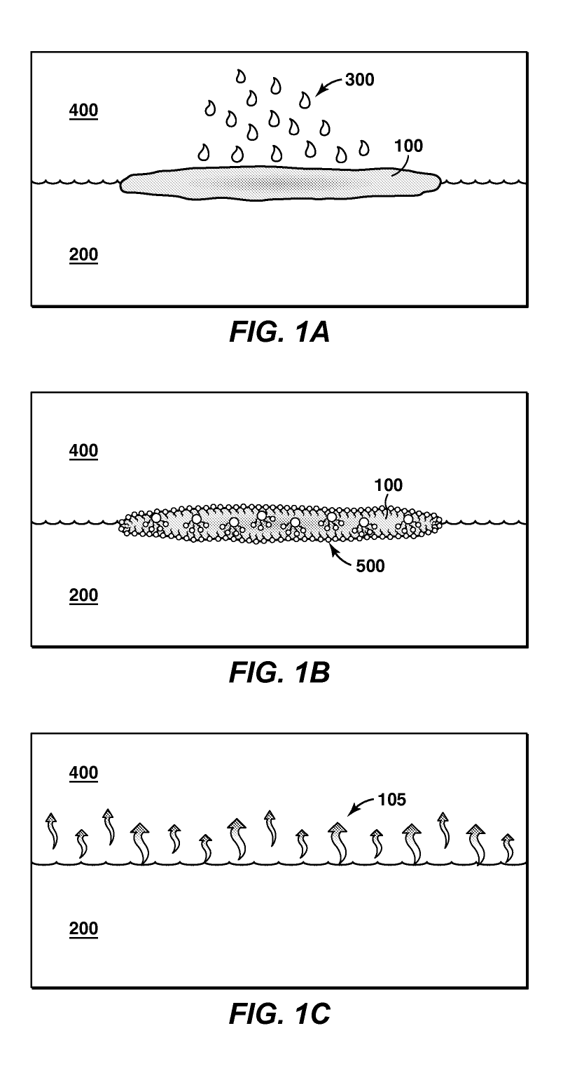

FIG. 1 is an exemplary illustration of the action of oil spill treatment composition comprising spreading agents. In FIG. 1A, the oil spill 100 is floating on the surface of a body of water 200 and the oil spill treatment composition 300 is falling in droplets. In FIG. 1B, the oil spill treatment composition 300 is located at the oil-water interface 400. In FIG. 1C, in low energy seas, the oil spill treatment composition may cause the oil to spread to an invisible sheen, thereby promoting evaporation of volatile oil spill components 105.

In particular embodiments, the oil spill is an oil-in-water emulsion. Oil-in-water emulsions tend to be viscous due to their water content and resistant to dispersants. The present compositions comprising spreading agents may advantageously cause the breakup of such oil-in-water or “chocolate mousse” type emulsions. Without wishing to be bound by theory, the inventors surmise that when the oil continuous phase of the emulsion is spread to a film thinner than the diameter of the entrained water droplets, these water droplets burst when they reach the oil-water interface, thereby expelling the water from the emulsion and causing breakup of the emulsion. Examples 4-6 demonstrate this advantage.

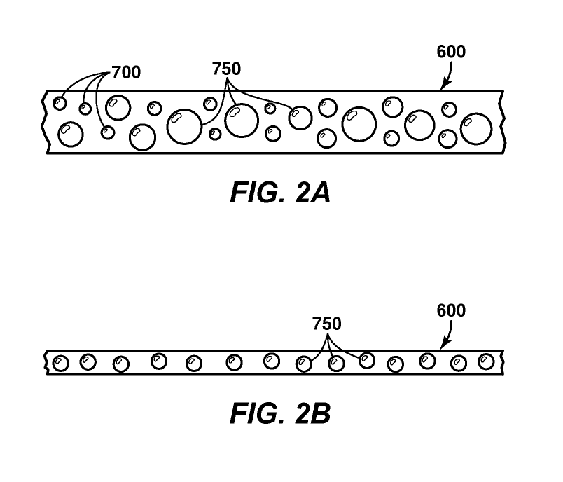

FIG. 2 is an exemplary illustration of the effect of thinning of the oil spill on entrained water droplets, such as those in an oil-in-water emulsion. FIG. 2A and FIG. 2B are representations of a cross-section of an exemplary oil-in-water emulsion. In FIG. 2A, the oil spill 600 is an oil-in-water emulsion and comprises large water droplets 700 and smaller water droplets 750. In FIG. 2B, after the spill has thinned, only the smaller water molecules 750 remain. The larger water droplets 700 have been expelled from the emulsion 600.

One or more embodiments of the present invention further provide methods of treating spilled oil on a body of water comprising: providing an oil spill treatment composition, wherein the oil spill treatment composition comprises one or more dispersant; admixing the dispersant with a crude or refined oil; and contacting the spilled oil with the oil spill treatment composition to disperse at least a portion of the oil into the water column.

The effectiveness of a dispersant in relation to its ability to remove oil spills from the water surface can be measured qualitatively, or in different more quantitative ways. A qualitative technique for measuring dispersion effectiveness is the Paddle Mixer Dispersant Efficiency Test. A quantitative dispersion effectiveness test is the EXDET Dispersant Effectiveness Test (Becker, K. W., Walsh, M. A., Fiocco, R. J., Curran, M. T., “A New Laboratory Method for Evaluating Oil Spill Dispersants” International Oil Spill Conference pp. 5407-5510 (Tampa, Fla. 1993) or the EPA Baffled Flask Test (Venosa, A. D., King, D. W., and Sorial, G. A., “The Baffled Flask Test for Dispersant Effectiveness: A Round Robin Evaluation of Reproducibility and Repeatability,” Spill Science & Technology Bulletin, 2002, 7(5-6), 299-308). Some other tests include, for example, wave basin tests, broken ice tests, finite difference models, the Mackay test, the rotating flask test, and others known to those of skill in the art.

Various methods may be utilized for delivering an oil spill treatment composition to an oil spill on a body of water. One benefit of these compositions over other oil-spill response options is the speed of application. In some embodiments, the contacting step comprises spraying the oil spill treatment composition onto the surface of the spill. In preferred embodiments, the composition is liquid, and is sprayed, for example through a nozzle, from a variety of application platforms or vehicles such as boats, helicopters, or airplanes. In some embodiments, the spraying may be aerial. In particular embodiments, the aerial application of the sprayed composition may be by flying vehicle such as an airplane or helicopter.

In other embodiments, the contacting step comprises injecting the oil spill treatment subsea to prevent the formation of thick oil slicks.

Typically, crude oils will increase in viscosity as they age after a spill; either by loss of volatile components such as the “light ends,” the formation of emulsions, or by temperature reduction from contact with cold water. As a result, the window of opportunity for dispersant usage can be limited to a certain period of time. For arctic climates, the viscosity of many oils can increase too quickly for conventional dispersants to be effective. Oil spill treatment compositions of the present disclosure may be particularly useful in such cases.

In one or more embodiments, the present disclosure also relates to:

1. An oil spill treatment composition comprising:

one or more surfactants formulated to reduce the thickness of oil floating on the surface of a body of water (preferably the surfactant is one or more of a surfactant having a hydrophile-lipophile balance of less than about 10 (preferably of 5 or less), and a silicone having a low hydrophile-lipophile balance);

one or more optional solvents (preferably an organic solvent, a silicon-comprising solvent, or a crude or refined oil having the same or similar composition as the oil spill to be treated; preferably dearomatized kerosene, isoparafins, crude oil, refined oil, and ethylene glycols, or a crude or refined oil having the same or similar composition as the oil spill to be treated; preferably the solvent is a crude or refined oil having the same or similar composition as the oil spill to be treated); and

one or more optional additives (preferably salts, surfactants, additional fluid-loss-control additives, gas, nitrogen, carbon dioxide, surface-modifying agents, tackifying agents, foamers, additional corrosion inhibitors, scale inhibitors, catalysts, clay-control agents, biocides, friction reducers, antifoam agents, bridging agents, dispersants, flocculants, H₂S scavengers, CO₂ scavengers, oxygen scavengers, lubricants, viscosifiers, breakers, weighting agents, relative-permeability modifiers, resins, particulate materials, wetting agents, coating-enhancement agents, and the like; preferably a tackifying agent; preferably polyisobutylene).

2. The oil spill treatment composition of paragraph 1, wherein the surfactant is a crosslinked alkylated silicone (preferably cetyl dimethicone).
3. The oil spill treatment composition of paragraphs 1 and 2, wherein the volume ratio of the crude or refined oil to the surfactant is in the range of from about 10:90 to about 90:10 (preferably from about 20:80 to about 80:20, preferably from about 30:70 to 70:30, more preferably about 50:50).
4. The oil spill treatment composition of paragraphs 1 to 3, comprising about 25 to 75 vol. % cetyl dimethicone and about 25 to 75 vol. % crude or refined oil.
5. A method of treating spilled oil on a body of water comprising:

providing the oil spill treatment composition of paragraphs 1 to 4; and

contacting the spilled oil with the oil spill treatment composition to spread at least a portion of the oil, thereby reducing the thickness of the film.

6. The method of paragraph 5, wherein the thickness of the film is reduced by at least by at least 90% (preferably, at least 99%, preferably at least 99.9%, or preferably at least 99.99%).
7. The method of paragraphs 5 and 6, wherein contacting comprises at least one of spraying the oil spill treatment composition onto the film of spilled oil and injecting the oil spill treatment subsea into oil released subsea.
8. The method of paragraphs 5 to 7, wherein the oil spill is a water-in-oil emulsion.
9. A method of manufacturing the oil spill treatment composition of paragraphs 1 to 4 comprising:

admixing one or more selected surfactants to form an oil spill treatment composition formulated to reduce the thickness of a film of spilled oil,
wherein the surfactant is one or more of:
(a) a surfactant having a hydrophile-lipophile balance of less than about 10 (preferably about 5 or less); and
(b) a silicone having a low hydrophile-lipophile balance (preferably a crosslinked alkylated silicone, preferably cetyl dimethicone);

optionally admixing a solvent (preferably an organic solvent, a silicon-comprising solvent, or a crude or refined oil having the same or similar composition as the oil spill to be treated; preferably dearomatized kerosene, isoparafins, crude oil, refined oil, and ethylene glycols, or a crude or refined oil having the same or similar composition as the oil spill to be treated; preferably the solvent is a crude or refined oil having the same or similar composition as the oil spill to be treated); and

optionally admixing one or more additives (preferably salts, surfactants, additional fluid-loss-control additives, gas, nitrogen, carbon dioxide, surface-modifying agents, tackifying agents, foamers, additional corrosion inhibitors, scale inhibitors, catalysts, clay-control agents, biocides, friction reducers, antifoam agents, bridging agents, dispersants, flocculants, H₂S scavengers, CO₂ scavengers, oxygen scavengers, lubricants, viscosifiers, breakers, weighting agents, relative-permeability modifiers, resins, particulate materials, wetting agents, coating-enhancement agents, and the like; preferably a tackifying agent; preferably polyisobutylene).

10. An oil spill treatment composition comprising:

one or more chemical dispersants (preferably the chemical dispersant comprises: (a) from about 5 to 15 wt % sorbitan monooleate, (b) from about 15 to 25 wt % polyoxyethylene sorbitan monooleate (c) from about 20 to 40 wt % polyoxyethylene sorbitan trioleate and (d) from about 25 to 50 wt % sodium dioctyl sulfosuccinate); and

one or more crude or refined oils having the same or similar composition as the oil to be treated.

11. A method of treating spilled oil on a body of water comprising:

providing the oil spill treatment composition of paragraph 10; and

contacting the spilled oil with the oil spill treatment composition to disperse at least a portion of the oil (wherein contacting comprises at least one of spraying the oil spill treatment composition onto the film of spilled oil and injecting the oil spill treatment subsea into oil released subsea).

12. A method of manufacturing the oil spill treatment composition of paragraph 11 comprising:

admixing one or more chemical dispersant (preferably the chemical dispersant comprises: (a) from about 5 to 15 wt % sorbitan monooleate, (b) from about 15 to 25 wt % polyoxyethylene sorbitan monooleate (c) from about 20 to 40 wt % polyoxyethylene sorbitan trioleate and (d) from about 25 to 50 wt % sodium dioctyl sulfosuccinate) with one or more crude or refined oil (preferably wherein the crude or refined oil is collected during the spill event by skimming the spill oil),

wherein the crude or refined oil that has the same or similar composition as the spilled oil to be treated.

### EXAMPLES

In all examples herein, tests were conducted using salt water having a salinity equivalent to seawater.

### Examples 1-8

### Oil Treatment Compositions Comprising Spreading Agents

### Examples 1-3

### Effects of Oil Spill Treatment Composition on Heavy Fuel Oils

An embodiment of the oil spill treatment composition of the present invention was prepared as follows. Silwax® CR-5016 (obtained from Siltech LLC, Dacula, Ga.) was dissolved in heavy fuel oil (“HFO” having a viscosity of 4000 cS at 77° F.) in an amount equivalent to 2 vol. % to provide a treated HFO.

### Example 1

Treated HFO (0.016 mL) was placed in a 5 inch evaporating dish (dish A) containing sufficient water to cover the entire bottom of the dish. HFO alone (0.016 mL) was placed in a second 5 inch evaporating dish (dish B) containing sufficient water to cover the entire bottom of the dish, as a control. The Silwax®-treated HFO in dish A immediately spread into a uniform light orange-red colored translucent film over the entire surface of the water. The untreated HFO in dish B remained as a single, discrete, dark colored, small diameter lens of oil floating on the surface of the water. Both evaporating dishes were then subjected to gentle agitation.

After agitation, the oil film in dish A was observed to remain a uniform film over the entire surface of the water. In contrast, the lens of the untreated HFO in dish B congealed to a viscous cohesive oil that adhered in several discrete clumps to the sides and bottom of the glass dish. The Silwax®-treated sample appeared to maintain its stability, even after agitation.

### Example 2

Larger scale tests were conducted using 9.25″×11.75″ aluminum pans, containing sufficient water to cover the bottom of the pan. In these tests, 0.1 mL of treated HFO was released into one pan (Pan A), and 0.1 mL of untreated HFO was applied to the water surface in a second pan (Pan B).

The treated HFO in pan A maintained a light orange-red colored uniform film over the entire surface of the water, and spread up to the sides of the test pan. In contrast, the untreated HFO in pan B adhered in dark colored discrete clumps to the sides and the bottom of the dish.

For a more accurate assessment of the limits of spreading, the test was repeated using a smaller sample volume (0.016 mL) of the treated oil in a third 9.25″×11.75″ aluminum pan (Pan C). The treated HFO formed an almost colorless uniform film over the entire surface of the water, evidence by a silver sheen on the water surface. If the 0.016 mL sample of oil had spread uniformly over the water surface, the calculated surface oil film would be 0.23 microns thick. Using Table 1, an oil film thickness of 0.23 microns would result in traces of color rather than the silver sheen observed. On closer observation, part of the treated oil had spread up the sides of the pan and was not on the water surface. Therefore the need for a larger water surface area, wherein the treated oil would not be confined, was evident and led to Example 3, below.

### Example 3

Larger scale tests were conducted using a 24″×20″ water reservoir. This reservoir has 4.5 times the surface area of the aluminum pan in Example 2. Initially, 0.1 mL of untreated HFO was applied to the water surface and formed a dark colored lens approximately 2.5 cm in diameter. The lens expanded to 5 cm in diameter and remained in that condition with no further spreading.

In another test, 0.1 mL treated HFO was applied to the water surface. After 10 minutes the treated HFO spread to a silver sheen. Complete and uniform spreading of the 0.1 mL sample would lead to a calculated oil thickness of 0.3 microns and result in some color rather than the silver sheen. Again, upon close observation, there was evidence of oil clinging on the sides of the water reservoir, which would account for less than the calculated amount of oil in the surface film and the silver sheen rather than bands of color.

In a final test, only 1 drop (0.016 mL) of the treated HFO was released into the reservoir. This volume, if uniformly spread over the entire surface area of the reservoir, would result in a calculated oil thickness of 0.051 microns, which should result in only a silver sheen on the surface if no excess oil clung to the walls of the container (see Table 1). At the conclusion of the test, a visible silver sheen was readily seen with no oil adhering to the side walls.

### Examples 4-5

### Effect of Oil Treatment Compositions on Water-in-Oil Emulsions

Based on Examples 1-3 that demonstrated the oil spreading capability of Silwax®, the treatment of water-in-oil emulsions typical of those that form after some oil spills was investigated. This so-called “chocolate mousse” is viscous and is usually more difficult to disperse due to its high viscosity.

A representative chocolate mousse emulsion was generated by blending viscous San Joaquin Crude Oil and Arab Medium Crude Oil, which contained the indigenous surfactants needed to form emulsions (R. F. Lee, “Isolation and Identification of Compounds and Mixtures which Promote and Stabilize Water In Oil Emulsions,” MSRC Technical Report Series 95-002, 1995). The chocolate mousse emulsion was generated by mixing together 20 mL San Joaquin Crude Oil, 5 mL Arab Medium Crude Oil, and 10 mL sea water.

A treated chocolate mousse emulsion was prepared by combining the chocolate mouse emulsion and an amount of Silwax® equivalent to 2 vol. %.

### Example 4

Water (800 mL) was placed into a 7¼″ diameter dish. Then 0.2 mL of the emulsion was added to the water surface. In a second 7¼″ diameter dish, 0.2 mL of the treated emulsion was added. The behavior of the emulsions was observed over time.

After 24 hours, the treated emulsion had spread to a light brown sheen. Total spreading was limited by the surface area of the dish. After spreading over the complete water surface, some of the slick spread up the sides of the beaker. In contrast, most of the volume of the untreated emulsion stayed as a dark brown lens.

A microscope study was then conducted to examine the composition of the emulsified water for both tests. The dark brown slick of the untreated emulsion contained the original amount of emulsified water droplets. These ranged in diameter from 1 to 0.05 mm with some droplets as small as 0.01 mm. In contrast, the treated emulsion only contained 0.01 mm diameter droplets.

The inventors surmise that the Silwax® treatment caused the oil continuous phase of the emulsion to spread to a film thinner than the diameter of the larger entrained water droplets. As the slick thinned, larger water droplets burst when they reach the oil-water interface, thereby expelling the water from the emulsion. Hence the treated emulsion has been substantially dewatered. Note that the treated emulsion was restrained from possibly spreading further by the limits of the container. Presumably, if unconstrained the treated emulsion may spread too thin to incorporate any emulsified water droplets. Therefore, the above tests were repeated in a larger water reservoir to permit unrestricted spreading of the test oil in Example 5.

### Example 5

Water was placed into a 100 square inch pan. Treated chocolate mousse (0.2 mL) was added. After 1 hour a thin brown sheen persisted. As noted by the oil coating on the sides of the pan, the 100 square inch pan still restricted, to a lesser degree, the complete spreading of the emulsion. Therefore, smaller amounts of the treated emulsion (0.1 and 0.05 mL) were used in the 100 square inch pans.

With 0.1 mL of treated emulsion there was still a very thin brown sheen. However, after 1 hour, the 0.05 mL treated emulsion was clear with no visually detectable oil film. A microscope study of the water surface also found no detectable presence of oil.

Finally, since the amount of treated emulsion (0.05 mL) was quite small, a 180 square inch pan was obtained, and the test was repeated with a 0.1 mL test volume of emulsion. The surface of the test pan showed no trace of oil.

### Examples 6-8

### Effect of Direct Application of Oil Spill Treatment Compositions to Spilled Oil

Three different direct application strategies were investigated: direct application to the spilled oil of pure Silwax®, of Silwax® in solution, and of Silwax® in spilled oil.

### Example 6

### Direct Addition Of Silwax®

A 100 square inch aluminum pan was filled with sufficient water to cover the bottom of the pan. Four mLs of heavy fuel oil (HFO 4027, having a viscosity of 2350 cS at 77° F.,) was spilled in the water. Pure Silwax® CR-5016 was added dropwise to the surface of the spilled oil. After 2 hours, minimal spreading was observed.

### Example 7

### Application of Silwax® in Polyisobutylene

A 100 square inch aluminum pan was filled with sufficient water to cover the bottom of the pan. Four mLs of HFO 4027 was spilled in the water. A solution of Silwax® in polyisobutylene was added dropwise to the surface of the spilled oil. After 2.5 hours, the spilled oil retained a small lens diameter and did not spread. The inventors surmised that the Silwax® may have herded the spill.

### Example 8

### Application of Silwax® in Spilled Oil

A 100 square inch aluminum pan was filled with sufficient water to cover the bottom of the pan. Four mLs of HFO 4027 was spilled in the water. 0.2 mLs of a mixture of Silwax in HFO 4027 (50:50) was added dropwise to the surface of the spilled oil. After 2 hours, the spilled oil had spread to cover about one third of the surface of the water. After 5 hours, the spilled oil had spread to cover the entire surface of the water. The inventors have surprisingly found that use of an oil having the same composition as the spilled oil allows the Silwax® to mix into the spill and cause spreading. Using the same or similar oil as the spilled oil as a solvent may allow the aerial application of these oil spill treatment compositions.

### Examples 9 & 10

### Oil Treatment Compositions Comprising Dispersants

The oil to be treated was Alaskan North Slope (ANS) crude.

### Example 9

15% weathered ANS crude (2 mL) was added to a 600 mL glass beaker, equipped with a stir bar and filled with 450 mL water.

COREXIT 9500 (0.1 mL) was added to the mixture and the mixture was stirred at a low setting using a laboratory vortexer, representative of a low energy environment. After 10 minutes, no dispersion of the oil into the water column was observed.

The mixture was then stirred at a high setting. After 10 minutes, excellent dispersion of the oil into the water was observed. This control example serves to validate that COREXIT 9500 does not disperse weathered ANS crude under conditions of low energy.

### Example 10

15% weathered ANS crude (2 mL) was added to a 600 mL glass beaker, equipped with a stir bar and filled with 450 mL water.

An oil spill treatment composition was formulated comprising COREXIT 9500 and 15% weathered ANS crude in a 1:1 volume ratio. The oil spill treatment composition (0.2 mL) was added to the mixture and the mixture was stirred at a low setting using a laboratory vortexer to produce a ¾″ vortex representative of a low energy environment. After 10 minutes, very good dispersion of the oil into the water column was observed. The mixture was then stirred at a high setting. After 10 minutes, excellent dispersion of the oil into the water was observed. The inventors have surprisingly found that that using the spilled oil as a solvent significantly enhanced the ability of the active surface agent, COREXIT 9500, to disperse weathered ANS crude under conditions of low energy.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

1. An oil spill treatment composition comprising:
one or more surfactants formulated to reduce the thickness of oil floating on the surface of a body of water; and
wherein the surfactant is a silicone having a low hydrophile-lipophile balance.

2. The oil spill treatment composition of claim 1, wherein the surfactant has a hydrophile-lipophile balance of less than about 10.

3. (canceled)

4. The oil spill treatment composition of claim 1, wherein the surfactant is a crosslinked alkylated silicone.

5. The oil spill treatment composition of claim 1, wherein the surfactant is cetyl dimethicone.

6. The oil spill treatment composition of claim 1, further comprising a solvent.

7. The oil spill treatment composition of claim 6, wherein the solvent is one or more of an organic solvent, a silicon-comprising solvent, or a crude or refined oil having the same or similar composition as the oil spill to be treated.

8. The oil spill treatment composition of claim 7, wherein the solvent is a crude or refined oil having the same or similar composition as the oil spill to be treated.

9. The oil spill treatment composition of claim 8, wherein the volume ratio of the crude or refined oil to the surfactant is in the range of from about 10:90 to about 90:10.

10. The oil spill treatment composition of claim 8, wherein the volume ratio of the crude or refined oil to the surfactant is about 50:50.

11. The oil spill treatment composition of claim 10, comprising about 50 vol. % cetyl dimethicone and about 50 vol. % crude or refined oil.

12. The oil spill treatment composition of claim 1, further comprising one or more additives.

13. An oil spill treatment composition comprising:
one or more chemical dispersants; and
one or more crude or refined oils having the same or similar composition as the oil to be treated.

14. The oil spill treatment composition of claim 13, wherein the chemical dispersant comprises: (a) from about 5 to 15 wt % sorbitan monooleate, (b) from about 15 to 25 wt % polyoxyethylene sorbitan monooleate (c) from about 20 to 40 wt % polyoxyethylene sorbitan trioleate and (d) from about 25 to 50 wt % sodium dioctyl sulfosuccinate

15. A method of treating spilled oil on a body of water comprising:
providing an oil spill treatment composition, wherein the oil spill treatment composition comprises one or more surfactants formulated to reduce the thickness of a film of spilled oil floating on the surface of a body of water, wherein the surfactant is a silicone having a low hydrophile-lipophile balance; and
contacting the spilled oil with the oil spill treatment composition to spread at least a portion of the oil, thereby reducing the thickness of the film.

16. The method of claim 15, wherein the thickness of the film is reduced by at least 90%.

17. The method of claim 15, wherein contacting comprises spraying the oil spill treatment composition onto the film of spilled oil.

18. The method of claim 15, wherein contacting comprises injecting the oil spill treatment subsea into oil released subsea.

19. The method of claim 15, wherein the surfactant has a hydrophile-lipophile balance of less than about 10.

20. The method of claim 15, wherein the surfactant is a silicone having a low hydrophile-lipophile balance.

21. The method of claim 20, wherein the surfactant is a crosslinked alkylated silicone.

22. The method of claim 20, wherein the surfactant is cetyl dimethicone.

23. The method of claim 15, wherein the oil spill treatment composition further comprises a solvent.

24. The method of claim 23, wherein the solvent is a crude or refined oil having the same or similar composition as the oil spill to be treated.

25. The method of claim 24, wherein the volume ratio of the crude or refined oil to the surfactant is in the range of from about 10:90 to about 90:10.

26. The method of claim 15, wherein the oil spill treatment composition further comprises one or more additives.

27. The method of claim 15, wherein the oil spill is a water-in-oil emulsion.

28. A method of treating spilled oil on a body of water comprising:
providing an oil spill treatment composition, wherein the oil spill treatment composition comprises one or more chemical dispersants and one or more crude or refined oils having the same or similar composition as the oil spill to be treated; and
contacting the spilled oil with the oil spill treatment composition to disperse at least a portion of the oil.

29. The method of claim 28, wherein the chemical dispersant comprises: (a) from about 5 to 15 wt % sorbitan monooleate, (b) from about 15 to 25 wt % polyoxyethylene sorbitan monooleate (c) from about 20 to 40 wt % polyoxyethylene sorbitan trioleate and (d) from about 25 to 50 wt % sodium dioctyl sulfosuccinate.

30. A method of manufacturing an oil spill treatment composition comprising:
admixing one or more selected surfactants to form an oil spill treatment composition formulated to reduce the thickness of a film of spilled oil,
wherein the surfactant is one or more of:
(a) a surfactant having a hydrophile-lipophile balance of less than about 10; and
(b) a silicone having a low hydrophile-lipophile balance.

31. The method of claim 30, further comprising admixing a solvent.

32. The method of claim 31, wherein the solvent is a crude or refined oil, wherein the crude or refined oil has the same or similar composition as the spilled oil to be treated.

33. The method of claim 30, further comprising admixing one or more additives.

34. A method of manufacturing an oil spill treatment composition comprising:
admixing one or more chemical dispersant with one or more crude or refined oil,
wherein the crude or refined oil that has the same or similar composition as the spilled oil to be treated.

35. The method of claim 34, wherein the crude or refined oil is collected during the spill event by skimming the spill oil.

36. The method of claim 34, wherein the chemical dispersant comprises: (a) from about 5 to 15 wt % sorbitan monooleate, (b) from about 15 to 25 wt % polyoxyethylene sorbitan monooleate (c) from about 20 to 40 wt % polyoxyethylene sorbitan trioleate and (d) from about 25 to 50 wt % sodium dioctyl sulfosuccinate.
